(19) United States
(12) Patent Application Publication
(10) Pub. No.: US 2005/0012334 A1
(43) Pub. Date: Jan. 20, 2005

(54) Method of manufacturing flow connectors having overmolded inserts and product produced thereby

(75) Inventor: Thomas R. Headley, Bryan, OH (US)

Correspondence Address: MICHAEL BEST & FRIEDRICH LLP, 3773 CORPORATE PARKWAY, SUITE 360, CENTER VALLEY, PA, 18034-8217, US

(73) Assignee: Ingersoll-Rand Company, Woodcliff Lake, NJ (US)

(21) Appl. No.: 10/622,159

(22) Filed: Jul. 17, 2003

(51) Int. Cl. F16L 25/00

(52) U.S. Cl. 285/390; 285/333; 285/423

(57) ABSTRACT

A method of manufacturing a flow connector and the flow-connector produced thereby are provided, including molding from a composition comprising at least one polymer a preform having a wall thickness defining an internal cavity and comprising at least two apertures through the wall thickness and joining a cap comprising at least one polymer onto at least one of the apertures. Also provided are a preform for manufacturing a flow-connector and a flow connector that include a wall thickness defining an internal cavity having a longitudinal axis and at least two apertures through the wall thickness, wherein one of the at least two apertures is located at the end of the longitudinal axis. The flow connector includes a cap joined to the wall thickness to cover one of the apertures located at the end of the longitudinal axis.

### FIELD OF THE INVENTION

This invention generally relates to methods for manufacturing fluid connectors and the fluid connectors produced thereby and more particularly to a polymer-containing fluid connector having flow openings that are adapted to be closed by a plastic joining process.

### DESCRIPTION OF THE PRIOR ART

Fluid handling devices such as diaphragm pumps, for example, include flow connectors or manifolds that are either attached to or integral with a housing and have one to several flow openings or ports being generally formed therein. Generally, an inlet flow opening is provided in an inlet manifold through which a fluid is supplied to the fluid handling device while a discharge flow opening is provided in an outlet manifold through which the fluid is discharged from the device. A flow conduit, such as a pipe, for supplying a fluid to the device is flow connected to the device at the inlet flow opening of the inlet manifold, and a discharge flow conduit for flowing a fluid from the handling device is flow connected to the discharge flow opening of the outlet manifold.

In some applications, these fluid devices are utilized to handle caustic chemicals such as acids, in other applications, comestible substances such as flowable foods and beverages can be pumped. In such applications, the component parts that are to contact the material to be handled are often constructed using materials that resist corrosion and are chemically compatible with the material being handled. In this regard, polymeric materials are often used for various pump components such as the manifolds which can be made using conventional injection molding techniques.

In one such process, a core pin is pulled in an injection mold during molding of the polymeric material to form a tubular shape. Typically the manifolds that can be produced using this process, however, include a configuration having a straight passage through which the core pin is pulled. Thus, unless a manifold has a flow opening located axially along its length into which a core pin can be inserted, another manufacturing method is typically selected. Such alternative methods include lost-core technologies in which the injection casting of a separate core, which duplicates the internal geometry of the manifold, is made from a low melting point alloy such as tin-bismuth. After injection molding a higher melting point plastic around the core, the molded part is then heated to melt and flow out the lower melting point core. Although effective in manufacturing manifolds having complex geometries, lost-core processes are more labor intensive and more costly than more straightforward injection molding techniques.

Additionally, in order to obtain polymeric manifolds or pump housings having different porting configurations, typically involves either individually manufacturing these parts with the requisite number of ports located in the proper porting orientations or with an excess number of ports of which the unwanted ports are mechanically plugged. The former option requires a variety of different injection molds and the inefficiencies associated with the manufacture and maintenance of an inventory of a variety of different parts. The latter option requires additional parts, gaskets, or sealants, and the potential for leaks during operation of a pump at the mechanically plugged port locations.

The foregoing illustrates limitations known to exist in present devices and methods. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

According to the present invention, a method of manufacturing a flow connector and the flow-connector produced thereby are provided, including molding from a composition comprising at least one polymer a preform having a wall thickness defining an internal cavity and comprising at least two apertures through the wall thickness and joining a cap comprising at least one polymer onto at least one of the apertures. Also provided are a preform for manufacturing a flow-connector and a flow connector that include a wall thickness defining an internal cavity having a longitudinal axis and at least two apertures through the wall thickness, wherein one of the at least two apertures is located at the end of the longitudinal axis. The flow connector includes a cap joined to the wall thickness to cover one of the apertures located at the end of the longitudinal axis.

The foregoing and other aspects will become apparent from the following detailed description of the invention when considered in conjunction with the accompanying drawing figures.

### BRIEF DESCRIPTION OF THE DRAWING FIGURES

FIG. 1 is a front elevational view of an outlet manifold according to the present invention;

FIG. 2 is a front elevational view of an inlet manifold according to the present invention;

FIG. 3 is a top view of an outlet manifold according to the present invention;

FIG. 4 is a top view of an inlet manifold according to the present invention;

FIG. 5 is a sectional view taken along line 5-5 of FIG. 3;

FIG. 6 is a sectional view taken along line 6-6 of FIG. 4;

FIG. 7 is a sectional view of FIG. 5 shown without and prior to the installation of a plastic cap;

FIG. 8 is a sectional view of FIG. 6 shown without and prior to the installation of a plastic cap;

FIG. 9 is an isometric view of a plastic cap for attachment to the inlet and outlet manifolds according to the present invention;

FIG. 10 is a side elevational view of the plastic cap shown in FIG. 9; and

FIG. 11 is a sectional side view of the plastic cap shown in FIG. 10.

### DETAILED DESCRIPTION OF THE INVENTION

The invention is best understood by reference to the accompanying drawings in which like reference numbers refer to like parts. It is emphasized that, according to common practice, the various dimensions of the component parts as shown in the drawings are not to scale and have been enlarged for clarity.

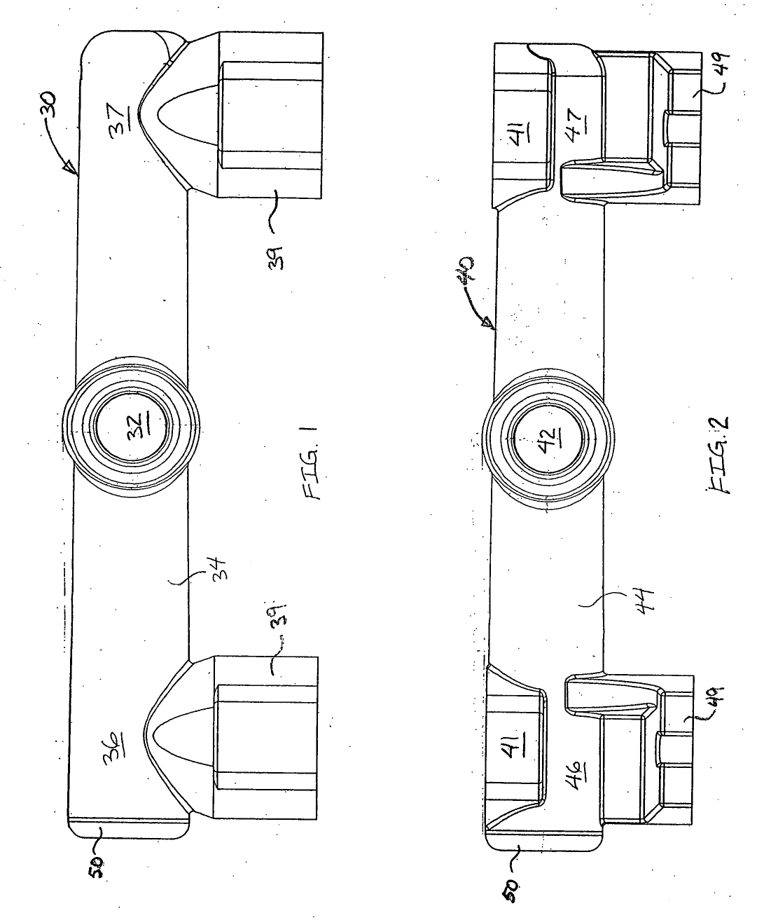

Referring now to the drawings, FIGS. 1 and 2 respectively show inlet and outlet flow connectors 40 and 30, respectively, according to the present invention. As used herein, the term “flow connector” includes manifolds, cases, or housings that are particularly useful in the manufacture of fluid handling pumps. For purposes of describing the invention, the connectors will hereinafter be referred to as outlet manifold 30 and inlet manifold 40, which may be attached to or integral with any fluid handling apparatus including any pump or compressor. Such apparatus includes, but is not limited to, a diaphragm pump which operates in a conventional manner well known to one skilled in the art like that shown and described in U.S. Pat. No. 5,848,878, the disclosure of which is incorporated herein by reference.

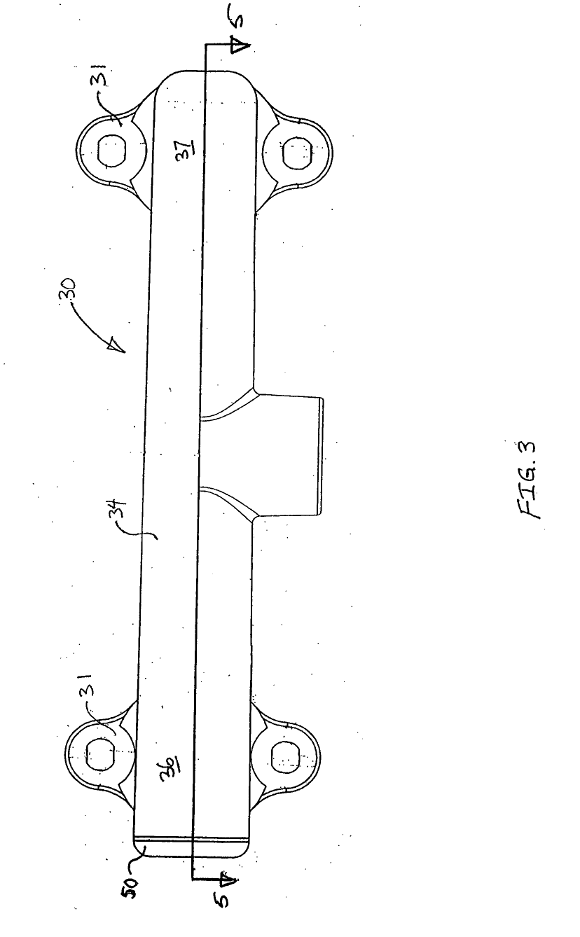

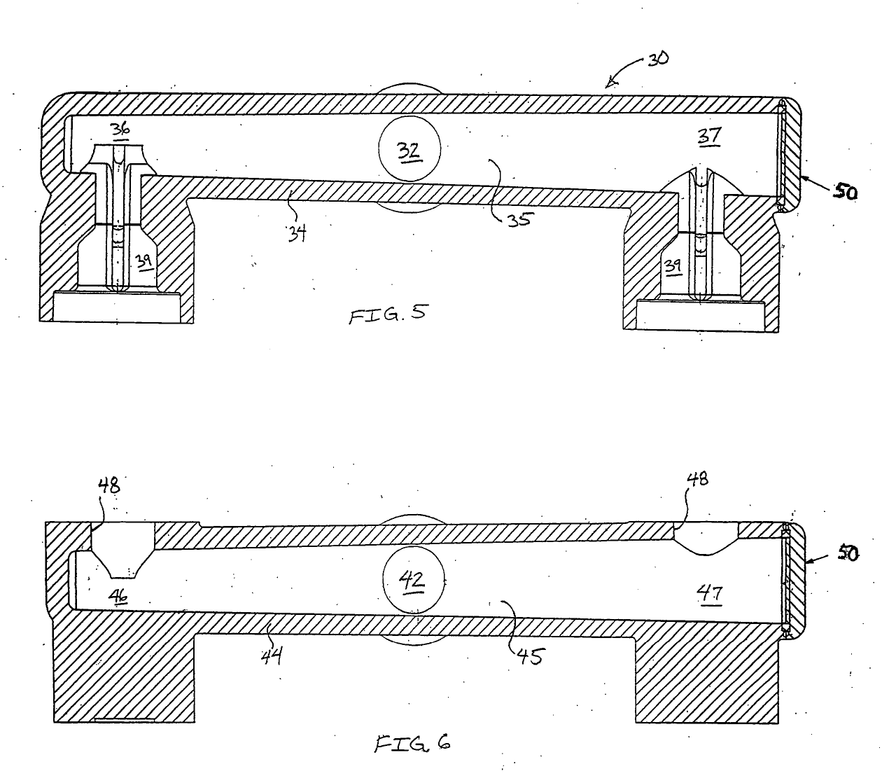

Turning to FIGS. 1-6, manifolds 30 and 40, respectively, comprise manifold bodies 34 and 44 having first ends 36 and 46 and second ends 37 and 47 opposite the first ends. Flow openings 32 and 42 are provided and located between the first and second ends of the manifolds. Flow passages 35 and 45, shown in FIGS. 5 and 6, respectively, extend through the manifold bodies and serve to flow connect flow openings 32, 42 with the first and second ends of the manifold bodies.

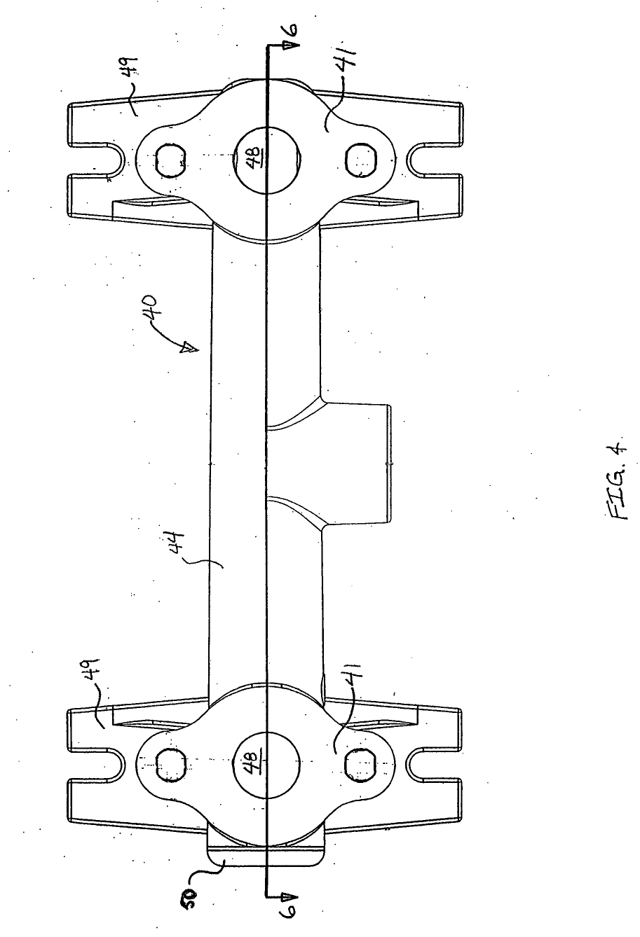

As shown in FIGS. 2 and 4, inlet manifold 40 includes two support feet 49 that are either made integral with or attached to the manifold body. The feet support the fluid pump when the pump is placed in the environment of use such as on a shelf or shop floor for example.

As shown in FIG. 5, outlet manifold 30 includes a check valve housing 39 at each of the outlet manifold ends 36 and 37. Each of the valve housings is adapted to enclose a fluid flow check valve such as a conventional ball-type check valve.

As shown in FIGS. 2, 4, and 6, inlet manifold 40 flow connects, via manifold body 44, the inlet flow opening 42 to openings 48 located in first end 46 and second end 47 that are fluidly connected to a pump housing (not shown) by attachment flanges 41, which are bolted or otherwise connected to the pump housing. In similar fashion, as shown in FIGS. 1, 3, and 5, outlet manifold 30 flow connects, via manifold body 34, the inlet flow opening 32 to check valve housings 39 located in first end 36 and second end 37 that are fluidly connected to a pump housing (not shown) by attachment flanges 31, which are bolted or otherwise connected to the pump housing.

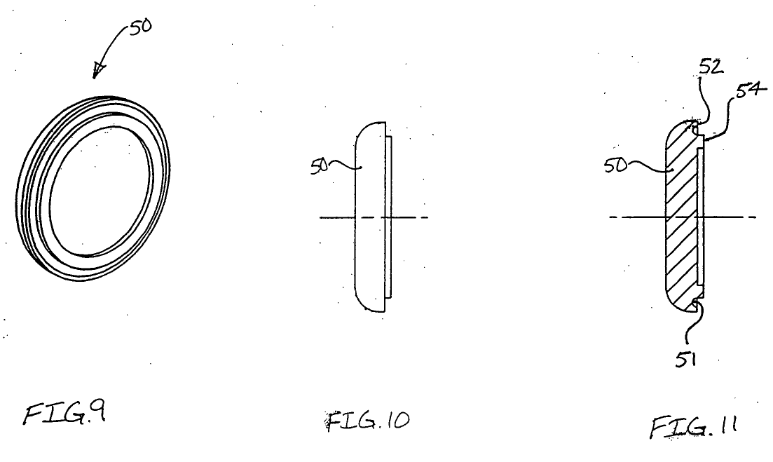

According to the present invention, a method of manufacturing a flow connector and the flow connector produced thereby are provided that includes both an injection molding and an additional polymer bonding/welding process. Preferably, the product produced is a manifold construction for fluid handling equipment. More specifically, a plastic bonding/welding process is employed to cap one or more ports in a plastic manifold. By using such plastic bonding/welding processes, a basic manifold configuration having a straight passage that is open on at least one end can be made by a standard injection molding process. The open end of each manifold is later closed off by capping using plastic bonding/welding to join a cap 50 shown in FIGS. 9, 10, and 11, as described in greater detail below.

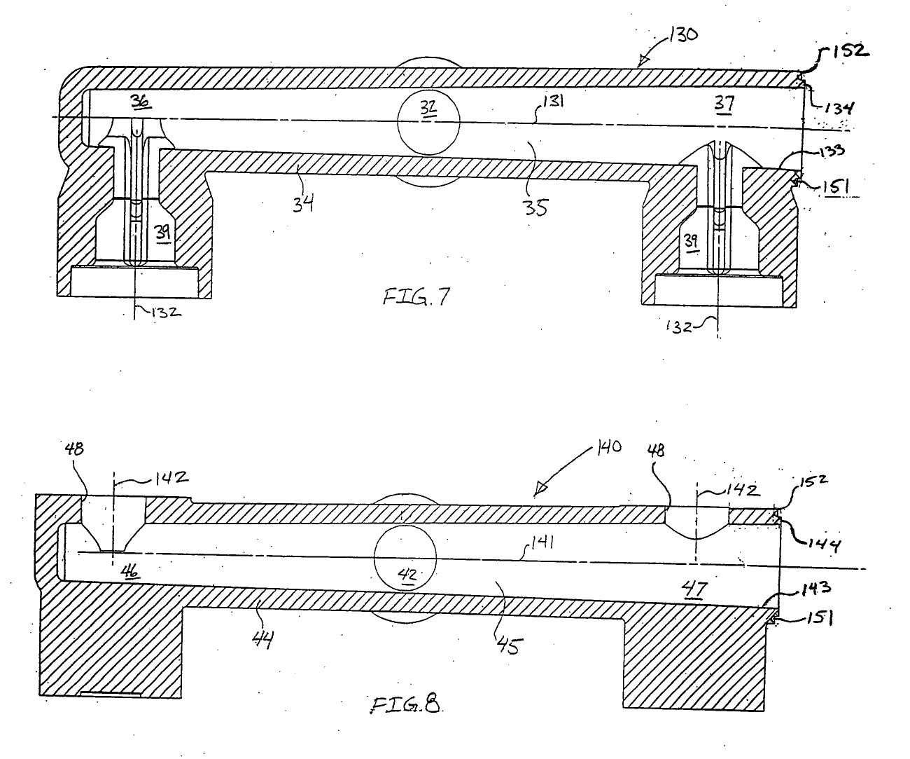

The manufacturing method according to the present invention incorporates the use of molded preforms 130 and 140 having a wall thickness defining an internal cavity, shown in FIGS. 7 and 8, to manufacture outlet manifold 30 and inlet manifold 40, respectively. Preforms 130 and 140 are designed to include apertures or core pin openings 133 and 143 that are provided at one end of each the manifold bodies 34, 44, which as shown in FIGS. 7 and 8 is the second end 37, 47 of each.

Because the core pin openings 133 and 143 are located axially along the length of the manifold bodies, a straightforward injection molding process may be used to form the preforms in which a core pin is moved inside injection molds (not shown) along longitudinal axes 131, 141 to mold a polymeric material into a substantially tubular shape to form manifold bodies 34 and 44. Additional core pins are also used along the perpendicular lines 132, 142 to form the check valve housings 39 and the openings 48 during the injection molding process.

The materials of the preform and cap are made of the same or similar polymer materials that are compatible for the joining process to be used to attach these components. Preferably, thermoplastic materials including, but not limited to, polypropylene (PP) or polyvinylidene fluoride (PVDF), are used which are well-known and commercially available polymers that may be formed and subsequently molded by a variety of conventional devices and methods, including injection molding which is known in the art. In an injection molding process, the thermoplastic material is generally preheated in a chamber to a temperature at which it will flow and then forced into a relatively cold closed mold cavity by means of high pressure applied through a plunger. A reciprocating screw may be employed to deliver the feed to the mold. As discussed above, core pins are used in the mold both to form the inner cavities around the longitudinal axes 131, 141 and the perpendicular axes 132, 142. Preferably, the flow openings that are to remain open for fluid connection to pipes or other fluid conduits that are threaded incorporate the threaded inserts for overmolding as disclosed in concurrently filed, commonly assigned and co-pending U.S. patent application, Attorney Docket No. MBF-010355-9137, the disclosure of which is incorporated herein by reference.

As shown in FIGS. 7 and 8, core pin openings 133 and 143 each terminate in a flange 134, 144 and cap 50, shown in FIG. 11, includes a flange 54, these flanges correspond in diameter and configured in thickness to mate and bond with each other. Preferably, a conventional plastic bonding/welding process that is used to join thermoplastic pipes, such as thermal-butt fusion welding or induction-heated joining method, is used to join the flange 54 of cap 50 to the flanges 134, 144 of manifold bodies 34, 44. As shown in FIGS. 7, 8, and 11, preferably a recess or reservoir 51, 151 and a lip 52, 152 are provided on both the cap and flanges of the manifold bodies to contain a melt front that occurs during the welding/bonding process in order to provide a more smooth and aesthetically pleasing surface condition.

With respect to the types of plastic bonding/welding processes that may be employed, the joining of polymeric members such as pipes by fusion is well known, with an exemplary patent in this regarding being U.S. Pat. No. 3,013,925. In applying thermal fusion welding to the method according to the present invention, the flanges of the manifolds and the caps are faced, butted together, and then heated. While in a softened state the flange of each manifold is axially advanced toward the flange of a cap to engage each other. The engaged cap is held in position until the softened ends solidify, effectively joining it to the manifold and sealing the core pin opening. This method of joining is highly effective in that the tensile and bursting pressure strengths of a properly formed joint are usually equal to or greater than the tensile and bursting pressure strengths of the plastic manifold body itself. Since a threaded closure is not required, down time is reduced, leaks are prevented and no extra parts are required to connect the flow conduit to the pump.

Induction-heating joining methods for joining polymeric members are also known and utilize polymer resins that are heated upon exposure to an induction-heating power supply. The polymers can be used as a separate adhesive or incorporated into the material of one or both of the structural members to be joined, which in applying to the method according to the present invention would be the cap and/or manifold bodies themselves. Typically, these polymers are resins that incorporate particulate susceptors made of an electrically conductive material that is heated upon exposure to an induction field, thereby causing adjoining the adjoining polymer surfaces to melt and bond. Such induction-heating joining methods are known in the art, with an exemplary process being the EMABOND® Process, materials for which are commercially available from Ashland Specialty Chemical Company, Dublin, Ohio.

Thus, as a result of the manufacturing method according to the present invention which combines polymer molding and polymer joining techniques, the need for a more costly and labor intensive method such as lost-core molding for manufacturing the manifold is eliminated. Additionally, plastic bonding/welding methods can be used to close and thereby select various configurations and porting orientations of manifolds from a generic manifold having a plurality of inlet/outlet ports provided. By capping unwanted ports of the generic manifold, any orientation of porting can be selected and configured from the manifold.

While embodiments and applications of this invention have been shown and described, it will be apparent to those skilled in the art that many more modifications are possible without departing from the inventive concepts herein described. For example, although the fluid connectors are shown and described as being for useful as manifolds for double diaphragm pumps and using specific exemplary combinations of injection molding and joining methods, it is envisioned that the manufacturing method and products that may produced can include other types of fluid connectors for other apparatus using combinations of other molding and joining techniques for polymers. It is understood, therefore, that the invention is capable of modification and therefore is not to be limited to the precise details set forth. Rather, various modifications may be made in the details within the scope and range of equivalents of the claims without departing from the spirit of the invention.

1. A method of manufacturing a flow connector, comprising:
providing at least one insert of a composition comprising at least one polymer and a reinforcement material selected from the group consisting of fiberglass, an inert material, and combinations thereof, the insert having a threaded bore for attachment to a threaded flow conduit, and
molding onto the at least one insert a composition comprising at least one polymer to form a flow connector having a wall thickness defining an internal cavity and comprising at least one aperture defined by the at least one insert through the wall thickness.

2. The method of manufacturing a flow connector according to claim 1 wherein the at least one polymer of the at least one insert is the same as the at least one polymer of the flow connector.

3. The method of manufacturing a flow connector according to claim 1 wherein the at least one polymer of the at least one insert and the at least one polymer of the flow connector are similar polymers that permit remelting and subsequent bonding at the interface between the at least one insert and the flow connector.

4. (Canceled)

5. The method of manufacturing a flow connector according to claim 1 wherein the reinforcement material is oriented circumferentially around the threaded bore of the insert.

6. The method of manufacturing a flow connector according to claim 1 wherein the molded flow connector defines a manifold body for fluid handling.

7. The method of manufacturing a flow connector according to claim 6 wherein the at least one aperture is a flow opening located in the manifold body.

8. The method of manufacturing a flow connector according to claim 1 wherein the molding is performed by injection molding.

9. The method of manufacturing a flow connector according to claim 8 wherein the injection molding is performed by providing the at least one insert on at least one corresponding core pin inside a mold in which the flow connector is molded.

10. The method of manufacturing a flow connector according to claim 1 wherein the at least one insert comprises circumferential grooves located on an exterior surface disposed around the threaded bore.

11. The method of manufacturing a flow connector according to claim 1 wherein the at least one insert comprises spurs located on an exterior surface disposed around the threaded bore.

12. The product-produced-by-the-method according to claim 1.

13. The product-produced-by-the-method according to claim 6.

14. The product-produced-by-the-method according to claim 10.

15. The product-produced-by-the-method according to claim 11.

16. An insert for manufacturing a flow connector, comprising:
a threaded bore for attachment to a threaded flow conduit, the insert being of a composition comprising at least one polymer and a reinforcement material selected from the group consisting of fiberglass, an inert material, and combinations thereof.

17. The insert according to claim 16 further comprising circumferential grooves located on an exterior surface disposed around the threaded bore.

18. The insert according to claim 16 further comprising spurs located on an exterior surface disposed around the threaded bore.

19. (Canceled)

20. The insert according to claim 16 wherein the reinforcement material is oriented circumferentially around the threaded bore of the insert.
